(19) United States
(12) Patent Application Publication
(10) Pub. No.: US 2009/0020503 A1
(43) Pub. Date: Jan. 22, 2009

(54) Substrate etching apparatus and substrate etching method

(75) Inventors: Jung-Sub Kim, Suwon-si (KR); Seung-Lyong Bok, Hwaseong-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/218,713

(22) Filed: Jul. 16, 2008

(30) Foreign Application Priority Data
Jul. 19, 2007 (KR) 2007-072319

(51) Int. Cl. B29D 11/00; C23F 1/08

(52) U.S. Cl. 216/23; 156/345.21; 216/24

(57) ABSTRACT

A substrate etching apparatus includes a chamber in which first and second insulating substrates are received, a blocking shutter, and a first spray head. The first spray head is arranged in the chamber and sprays an etchant toward the first insulating substrate. The blocking shutter surrounds end portions of the first and second substrates and isolates a first area in which the first insulating substrate is positioned from a second area in which the second insulating substrate is positioned.

### CROSS-REFERENCE TO RELATED APPLICATION

This application relies for priority upon Korean Patent Application No. 10-2007-72319 filed on Jul. 19, 2006 in the Korean Intellectual Property Office, the contents of which are herein incorporated by reference in its entirety.

### BACKGROUND OF THE INVENTION

1. Field of the Invention

The present invention relates to a substrate etching apparatus and a substrate etching method. More particularly, the present invention relates to a substrate etching apparatus capable of processing substrates having different shapes and a substrate etching method using the substrate etching apparatus.

2. Description of the Related Art

As a flat panel display, in general, various displays, such as a liquid crystal display, a plasma display panel, and organic electroluminescent displays are widely used. The flat panel display is applied to various electronic appliances such as a large-sized television set, a monitor of a notebook computer, a mobile phone, and so on.

The flat panel display includes at least one substrate. In the case of a liquid crystal display, two transparent glass substrates facing each other are used and a liquid crystal layer is interposed between the two substrates. The glass substrates for the liquid crystal display generally have a thickness of about 0.3 mm to about 0.7 mm. In accordance with the recent trend of lightness, compactness, and smallness of the liquid crystal display, a method that etches the glass substrate to reduce the thickness of the glass substrate has been developed. As a method of etching the glass substrate, a method of etching the glass substrate using an etchant and a method of mechanically etching the glass substrate are broadly used. However, since the two glass substrates are etched under the same etching condition in case of the conventional etching methods, the glass substrate for a color filter and the glass substrate for a thin film transistor have the same thickness. For instance, when the glass substrates having a thickness of 0.5 mm are etched, each glass substrate has the same thickness as 0.4 mm. 0.3 mm, 0.2 mm, and 0.1 mm. In case that a driving IC is directly integrated onto the display apparatus, the glass substrate for the color filter can be thin, so that the glass substrate for the color filter having a thickness of 0.1 mm and the glass substrate for the thin film transistor having a thickness of 0.5 mm are required.

In order to fabricate the display apparatus including the glass substrates each having different thicknesses or shapes, a protection film attaching method that attaches a protection film onto a surface of the glass substrate using an adhesive has been developed. However, when an adhesive force of the adhesive is weakened, the adhesive is readily degraded by the etchant and the etchant infiltrates into between the protection film and the glass substrate, thereby not etching the glass substrates as desired shapes.

Meanwhile, when the adhesive having strong adhesive force is applied, it is difficult to separate the protection film from the glass substrate, to thereby deteriorate the yield of the glass substrates for the display apparatus. Further, in case that a photolithography method using a photoresist is applied to etch the glass substrates, process step and process time remarkably increase, thereby causing deterioration of productivity of the glass substrates.

### SUMMARY OF THE INVENTION

The present invention provides a substrate etching apparatus capable of processing substrates to have different shapes.

The present invention also provides a substrate etching method using the substrate etching apparatus.

In one aspect of the present invention, a substrate etching apparatus includes a chamber, a blocking shutter, a first spray head, and a first etchant supplier.

The chamber includes a first area and a second area adjacent to the first area and receives a first substrate and a second substrate at a boundary between the first and second areas. The first and second substrates face each other. The blocking shutter is positioned at the boundary between the first and second areas and surrounds end portions of the first and second substrates to isolate the first area in which the first substrate is positioned from the second area in which the second substrate is positioned. The first spray head includes at least one nozzle that is arranged in the first area and faced to the first substrate and sprays a first etchant to the first substrate. The first etchant supplier contains the first etchant and supplies the first etchant to the first spray head.

The substrate etching apparatus may further include a second spray head and a second etchant supplier. The second spray head includes at least one nozzle that is arranged in the second area and faced to the first spray head while interposing the first and second substrates therebetween to spray a second etchant to the second substrate. The second etchant supplier contains the second etchant and supplies the second etchant to the second spray head.

The first spray head sprays the first etchant at a spraying speed different from a spraying speed of the second etchant from the second spray head, so that the first and second substrates may be etched to have different thicknesses.

The substrate etching apparatus further includes a fixing part surrounding end portions of the first and second substrates. The fixing part is positioned between the first substrate and the blocking shutter and between the second substrate and the blocking shutter.

The substrate etching apparatus may further include a gas layer formed between the blocking shutter and the firs and second substrates and between the blocking shutter and the fixing part. The gas layer prevents the first and second etchants from being moved to the second and first areas, respectively.

The first and second etchants have the same composition or the different composition, and one of the first and second etchants may include a water.

The first and second etchants may include fluoric acid, phosphoric acid, and nitric acid. The first and second etchants may include at least one of a glycol-containing medium and a glycerol-containing medium.

The first and second spray heads include at least one spray nozzle. The number of the first and second spray heads increases as a size of the first and second substrates increases. In order to improve the uniformity of the first and second substrates, the first and second spray heads may be movable to front, rear, right, and left directions while spraying the first and second etchants.

The chamber may further include a first etchant withdrawal pipe that drains out the first etchant provided to the first area and a second etchant withdrawal pipe that drains out the second etchant provided to the second area. The first etchant withdrawal pipe is connected to the first etchant supplier to provide the first etchant in the first area to the first etchant supplier, and the second etchant withdrawal pipe is connected to the second etchant supplier to provide the second etchant in the second area to the second etchant supplier.

In another aspect of the present invention, a method of etching a substrate is provided as follows. When a first substrate and a second substrate facing the first substrate are loaded into a chamber, a blocking shutter positioned inside the chamber is coupled with end portions of the first and second substrates to isolate a space inside the chamber into a first area in which the first substrate is positioned and a second area in which the second substrate is positioned. Then, a first etchant is sprayed to the first substrate to be differently etched from the second substrate.

The first and second etchants may include the same composition or the different composition, and the second etchant may include only water. Also, the first and second etchants include at least one of a glycol-containing medium and a glycerol-containing medium.

Further, the first and second etchants may be substantially simultaneously sprayed, and one of the first and second etchants may be sprayed to the first or second substrate.

According to the above, the substrate etching apparatus may substantially simultaneously etch several substrates to have the different thickness without additional processes.

### BRIEF DESCRIPTION OF THE DRAWINGS

The above and other advantages of the present invention will become readily apparent by reference to the following detailed description when considered in conjunction with the accompanying drawings wherein:

FIG. 1 is a diagram showing a substrate etching apparatus according to an exemplary embodiment of the present invention;

FIG. 2 is a diagram showing a substrate etching apparatus according to another exemplary embodiment of the present invention;

FIG. 3A is a diagram showing a blocking shutter and a fixing part of the embodiment of FIG. 1;

FIG. 3B is an enlarged view showing in greater detail a nozzle of the type used in the above-identified embodiments;

FIG. 4 is a diagram showing a substrate etching apparatus according to another exemplary embodiment of the present invention;

FIG. 5A is a plan view showing a substrate etching apparatus according to another exemplary embodiment of the present invention;

FIG. 5B is a cross-sectional view taken along a line I-I′ of FIG. 5A;

FIG. 6A is a plan view showing a substrate etching apparatus according to another exemplary embodiment of the present invention;

FIG. 6B is a cross-sectional view taken along a line II-II′ of FIG. 6A;

FIG. 7A is a plan view showing a substrate etching apparatus according to another exemplary embodiment of the present invention;

FIG. 7B is a cross-sectional view taken along a line III-III′ of FIG. 7A;

FIG. 8 is a perspective view showing a substrate etching apparatus according to another exemplary embodiment of the present invention;

FIG. 9 is a sectional view showing a portion of a display substrate fabricated utilizing an exemplary embodiment according to the present invention; and

FIG. 10 is a sectional view showing a portion of a display substrate fabricated utilizing another exemplary embodiment according to the present invention.

### DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

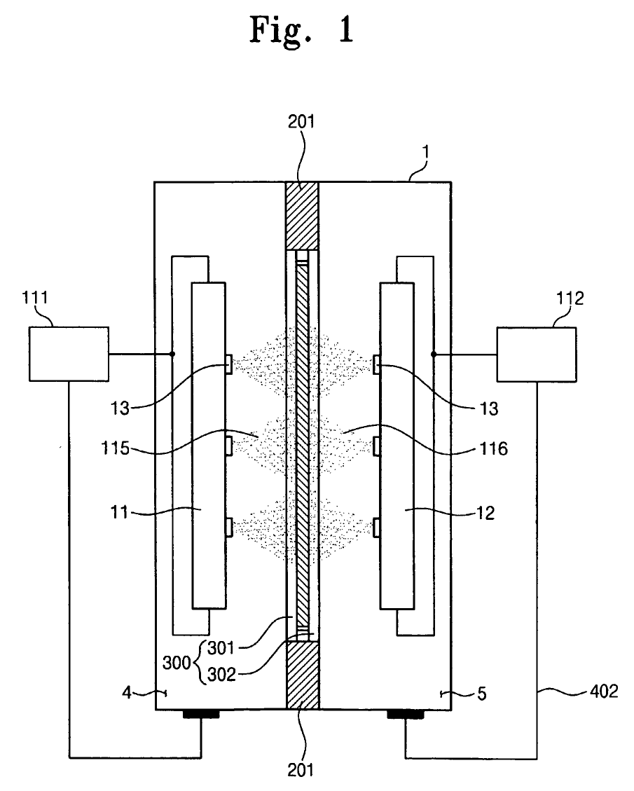

FIG. 1 is a diagram showing a substrate etching apparatus according to an exemplary embodiment of the present invention.

Referring to FIG. 1, a substrate etching apparatus includes a chamber 1, first and second etchant suppliers 111 and 112, first and second etchant spray heads 11 and 12, first and second etchant withdrawal pipes 401 and 402, and a blocking shutter 201. The chamber 1 may have various shapes such as a cylindrical shape, or a hexahedral shape. The chamber 1 is provided with an opening portion, not shown, formed therethrough, so that a display substrate 300 can be loaded into or loaded out from the chamber 1 through the opening portion. The display substrate 300 which includes a first insulating substrate 301 and a second insulating substrate 302 is loaded into the chamber 1 by a loader (not shown).

When the display substrate 300 is placed adjacent blocking shutter 201 and the blocking shutter 201 is moved into contact with the display substrate 300, a space inside the chamber 1 is divided into first and second etching areas 4 and 5 each of which is sealed from the other. Thus, various substances, such as etchant, etchant gas, gas generated during the etching process, may not be moved between the first and second etching areas 4 and 5. Also, although a first etchant 115 and a second etchant 116 may have the same compositions, they are not mixed with each other. Accordingly, the blocking shutter 201 has to seal the first and second etching areas 4 and 5 such that the etchant and the gas generated from the etchant are not moved between the first and second etching areas 4 and 5. In order to remove the gas generated from the etchant, the substrate etching apparatus may further include a gas vent system (not shown).

After dividing the space inside the chamber 1 into the first and second etching areas 4 and 5, the first and second etchant suppliers 111 and 112 supply the first and second etchants 115 and 116 to the first and second etchant spray heads 11 and 12, respectively. Each of the first and second etchant spray heads 11 and 12 includes at least one etchant spray nozzle 13, and the first and second etchants 115 and 116 are sprayed through the etchant spray nozzle 13. The first and second etchants 115 and 116 may have the same compositions and the same composition ratio. In the present exemplary embodiment, the first etchant 115 has a substantially different etch rate with respect to the first and second insulating substrates 301 and 302 from an etch rate of the second etchant 116 in order to allow the first and second insulating substrates 301 and 302 to be etched to different thicknesses.

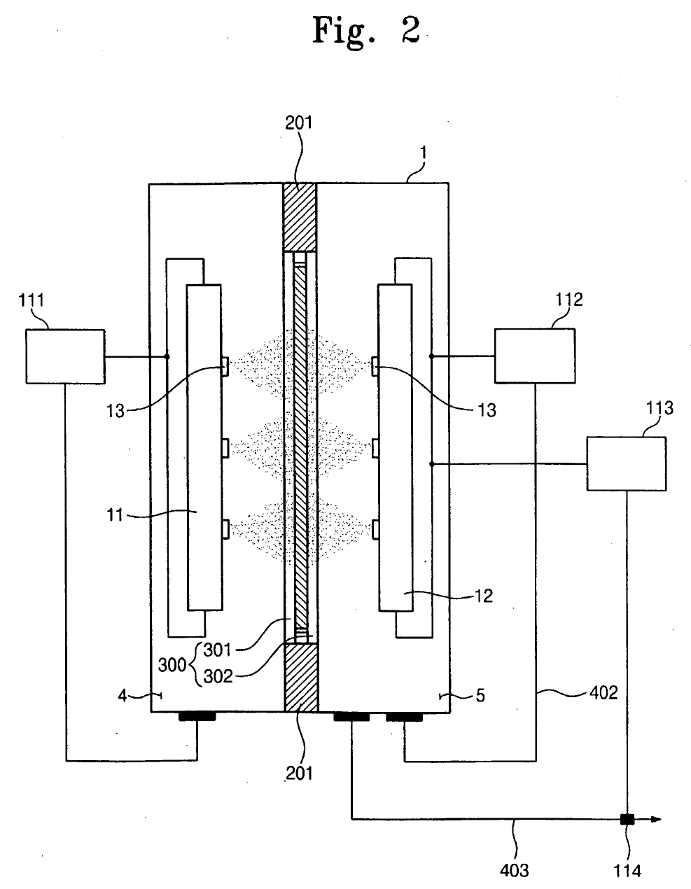

FIG. 2 is a diagram showing a substrate etching apparatus according to another exemplary embodiment of the present invention. In FIG. 2, the same reference numerals denote the same elements in FIG. 1, and thus the detailed descriptions of the same elements are not required.

As shown in FIG. 2, the substrate etching apparatus further includes a third etchant supplier 113. Thus, although the first and second etchants 115 and 116 have the same etch rate with respect to the first and second insulating substrates 301 and 302, when the first and second etchants 115 and 116 are sprayed to the first and second insulating substrates 301 and 302, respectively, by during the same time interval and the first etchant 115 is additionally supplied to the first insulating substrate 301 through the first etchant spray head 11 after blocking the supply of the second etchant 116 to the second etchant spray head 12, only the first insulating substrate 301 is additionally etched, so that the display substrate 300 having the first and second insulating substrates 301 and 302 that are etched in different thicknesses may be fabricated. Also, water may be supplied to the second insulating substrate 302 through the second etchant spray head 12 using the third etchant supplier 113 while the first insulating substrate 301 is additionally etched. Thus, the display substrate 300 may be prevented from being damaged even when the etchant is supplied to only one substrate of the first and second insulating substrates 301 and 302.

As shown in FIGS. 1 and 2, since the space inside the chamber 1 is divided into the first and second etching areas 4 and 5 each of which is sealed from the other by using the blocking shutter 201, although the etchant is sprayed to only the first insulating substrate 301 through the first etchant spray head 11, the second insulating substrate 302 is not affected by any external influence. Therefore, the first and second insulating substrates 301 and 302 may be substantially simultaneously etched under different etch conditions. Consequently, the substrate etching apparatus may reduce an etching time duration of the display substrate 300, thereby improving a product yield.

The chamber 1 may further include a first etchant withdrawal pipe 401, a second etchant withdrawal pipe 402, and a third etchant withdrawal pipe 403. The first and second etchant withdrawal pipes 401 and 402 withdraw the first and second etchants 115 and 116 sprayed from the first and second etchant spray heads 11 and 12 and provide back the first and second etchants 115 and 116 to the first and second etchant suppliers 111 and 112, respectively. The third etchant withdrawal pipe 403 is used to withdraw the etchant provided from the third etchant supplier 113 or to vent the etchant when the etchant sprayed to the display substrate 330 is not necessary to be withdrawn. In this case, a selection valve 114 is installed at the third withdrawal pipe 403, it may be decided that whether the etchant is withdrawn or vented.

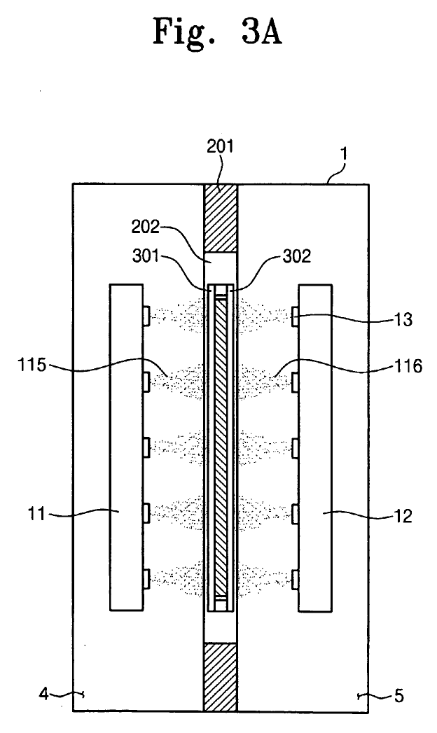

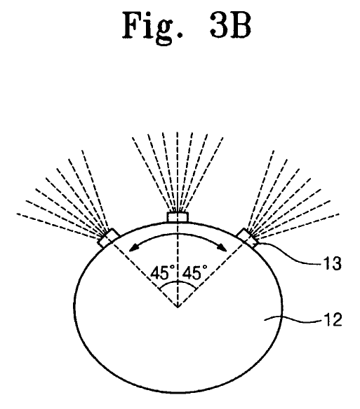

FIG. 3A is a diagram showing a blocking shutter and a fixing part of FIG. 1, and FIG. 3B is an enlarged view showing a nozzle part of FIG. 2A. In FIGS. 3A and 3B, the same reference numerals denote the same elements, and thus the detailed descriptions of the same elements are unnecessary.

FIG. 3A shows the display substrate 300 that is fixed to a fixing part 202, loaded into the chamber 1 by the loader (not shown), and etched by the etchants sprayed from the first and second etchant spray heads 11 and 12.

Referring to FIGS. 3A and 3B, the display substrate 300 is coupled to the fixing part 202, transferred into the chamber 1, and placed at the blocking shutter 201. The blocking shutter 201 is coupled with the fixing part 202. That is, the blocking shutter 201, the fixing part 202, and the display substrate 300 are coupled with each other, so that the space inside the chamber 1 is divided into the first and second etching areas 4 and 5 each of which is sealed from the other. Different from the above-described structure, the blocking shutter 201 may be integrally formed with the fixing part 202, and the display substrate 300 transferred by the loader (not shown) may be coupled with the fixing part 202 that is integrally formed with the blocking shutter 201.

Plural display substrates may be coupled with the fixing part 202, and the display substrates are securely coupled with the fixing part 202 such that the etchants, the etch gas, and the gas generated during the etching process are not moved between the first and second etching areas 4 and 5 through a region where the display substrates are coupled with the fixing part 202. The fixing part 202 may be formed of a metal or a polymer, such as stainless steel, Teflon, polyvinylchloride, which are not etched by the etchants. The fixing part 202 is integrally formed with the blocking shutter 201 to block flow of the etchants and the etch gas. As described above, the display substrate 300 may be directly coupled with the blocking shutter 201 without the fixing part 202 and placed inside the chamber 1.

Meanwhile, each of the first and second etchant spray heads 11 and 12 includes at least one spray nozzle 13. The first and second etchant spray heads 11 and 12 may be moved to front, rear, right, and left directions, and the spray nozzles may be arranged at the first and second etchant spray heads 11 and 12 in one generally vertical line or in a zigzag shape. According to a connection manner between the first etchant supplier 111 and the first etchant spray head 11 and between the second etchant supplier 112 and the second etchant spray head 12, a distance between the spray nozzles may be shortened as the spray nozzles are apart from the connection position between the first etchant supplier 111 and the first etchant spray head 11 and between the second etchant supplier 112 and the second etchant spray head 12. Also, the size of the spray nozzles may be enhanced as the spray nozzles are apart from the connection position between the first etchant supplier 111 and the first etchant spray head 11 and between the second etchant supplier 112 and the second etchant spray head 12. Further, each spray nozzle 13 may be provided with a valve (not shown) to control a spray amount of the etchant sprayed therethrough, so that the amount of the etchant sprayed through the each spray nozzle 13 according to positions of the display substrate 300, thereby uniformly etching the entire surface of the display substrate 300.

In the present exemplary embodiment, the display substrate 300 is vertically arranged during the etching process, however the display substrate 300 may be horizontally arranged during the etching process. In case that the display substrate 300 is vertically arranged, the spray amount of the etchant that is sprayed to an upper portion of the display substrate 300 needs to be increased compared with the spray amount of the etchant that is sprayed to a lower portion of the display substrate 300 since the etchant sprayed to the upper portion of the display substrate 300 flows toward the lower portion of the display substrate 300. In order to adjust the spray amount of the etchant, the size of the spray nozzle 13 or the valve of the spray nozzle 13 may be adjusted. Also, a spray angle of the etchant spray head and the spray nozzle 13 may be further adjusted, thereby uniformly etching the entire surface of the display substrate 300.

As shown in FIG. 3B, the second etchant spray head 12 is provided with at least two spray nozzles 13 that are arranged in a direction substantially perpendicular to a longitudinal direction of the second etchant spray head 12. Although not shown in FIGS. spray nozzles of the first echant spray head 11 are arranged the same as the spray nozzles of the second echant spray head 12. The number of the first and second etchant spray heads 11 and 12 is varied according to the size of the display substrate 300. That is, as the size of the display substrate 300 increases, the number of the first and second etchant spray heads 11 and 12 increases. The display substrate 300 is used for a display apparatus, and the display substrate 300 may include a transparent glass material or a plastic material if the display substrate 300 is used for a liquid crystal display. The display substrate 300 includes an upper substrate and a lower substrate facing the upper substrate. The upper and lower substrates are coupled with each other, and then are etched. When etching the upper and lower substrates, inner surfaces of the upper and lower substrates face each other, and outer surfaces of the upper and lower substrates are etched. In this case, an angle between two adjacent spray nozzles 13 to each other is about 45 degrees.

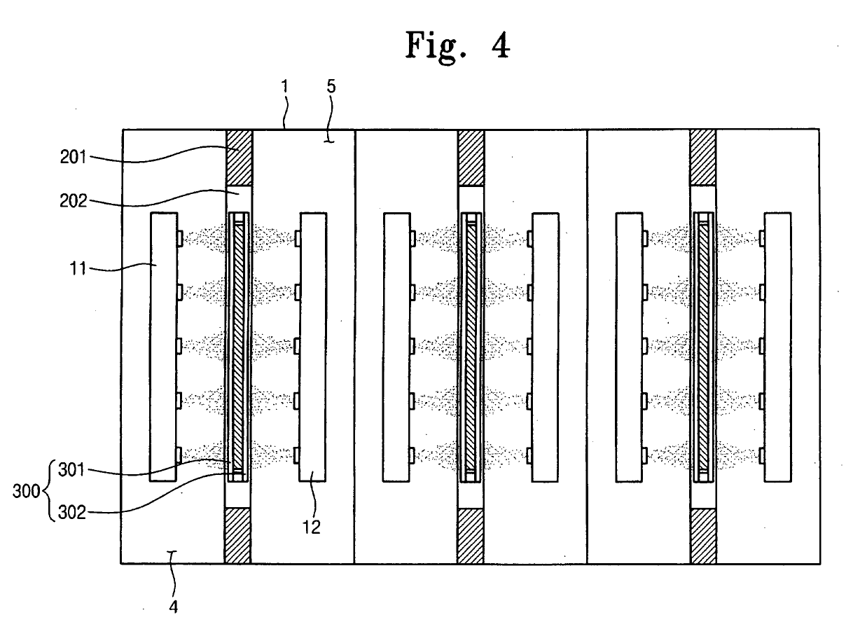

FIG. 4 is a diagram showing a substrate etching apparatus according to another exemplary embodiment of the present invention.

Referring to FIG. 4, in order to increase productivity, the substrate etching apparatus may include a plurality of chambers 1 that are coupled to each other, so that several display substrates 300 may be substantially simultaneously etched. Each chamber 1 is sealed from the other, and each chamber 1 is divided into the first and second etching areas 4 and 5 by the blocking shutter 201.

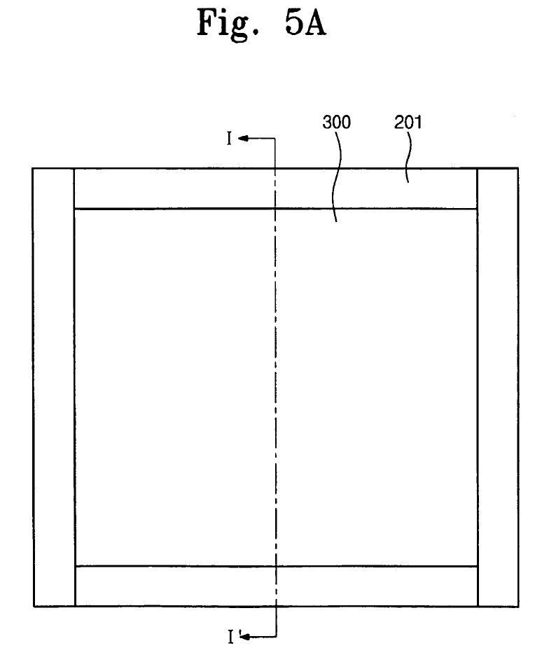

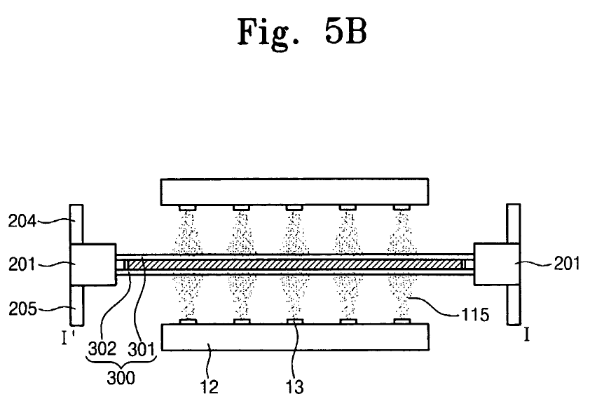

FIG. 5A is a plan view showing a substrate etching apparatus according to another exemplary embodiment of the present invention, and FIG. 5B is a cross-sectional view taken along a line I-I′ of FIG. 5A. In FIGS. 5A and 5B, the connection and structure of the blocking shutter 201 and the display substrate 201 have been described.

Referring to FIGS. 5A and 5B, the blocking shutter 201 may fix front, rear, left, and right portions of the display substrate 300 thereto. Also, the blocking shutter 201 further includes protruding portions 204 and 205 to prevent the etchant 115 sprayed from the etchant spray head 12 from being moved to the second etching area 5 from the first etching area 4.

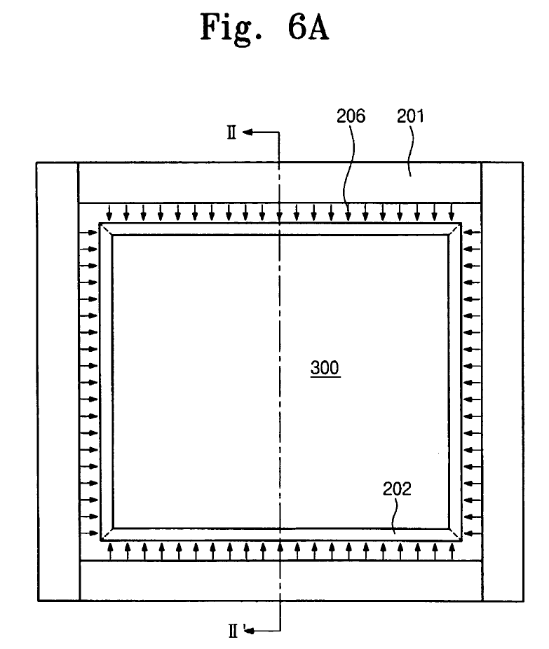

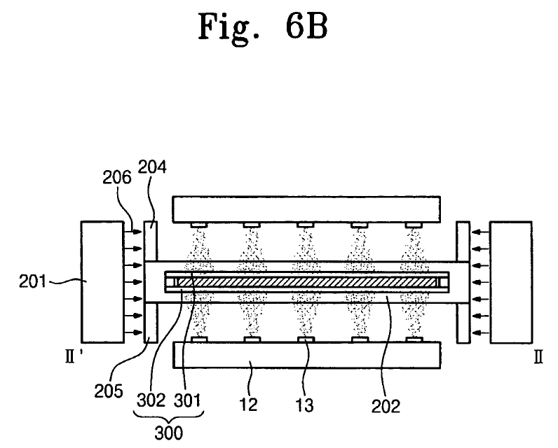

FIG. 6A is a plan view showing a substrate etching apparatus according to another exemplary embodiment of the present invention, and FIG. 6B is a cross-sectional view taken along a line II-II′ of FIG. 6A.

Referring to FIGS. 6A and 6B, the substrate etching apparatus further includes a gas layer 206 formed by injecting a gas between the blocking shutter 201 and the fixing part 202, thereby blocking the etchant sprayed from the etchant spray head 12 from being moved to the second etching area 5 from the first etching area 4. As an example of the gas for the gas layer 206, various gases, such as oxygen, nitrogen, and argon may be applied. As shown in FIG. 6A, in case that the blocking shutter 201 is directly coupled with the display substrate 300, the gas layer 206 may be applied to prevent the etchant from being moved to the second etching area 5 from the first etching area 4 through chinks between the blocking shutter 201 and the display substrate 300. The gas layer 206 may be formed adjacent to four sides of the blocking shutter 206.

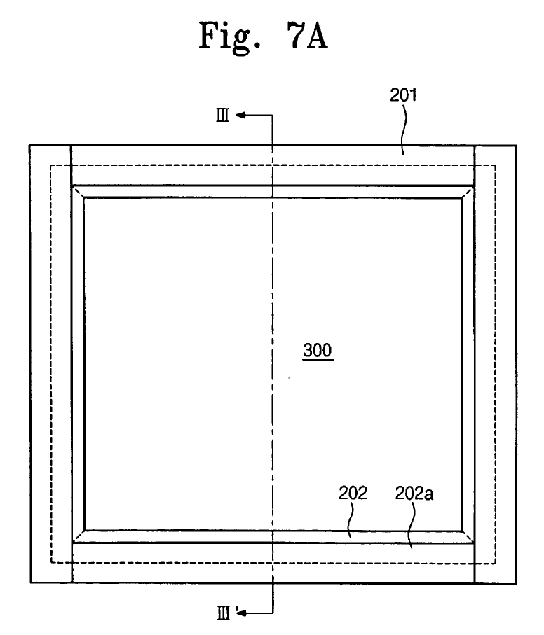

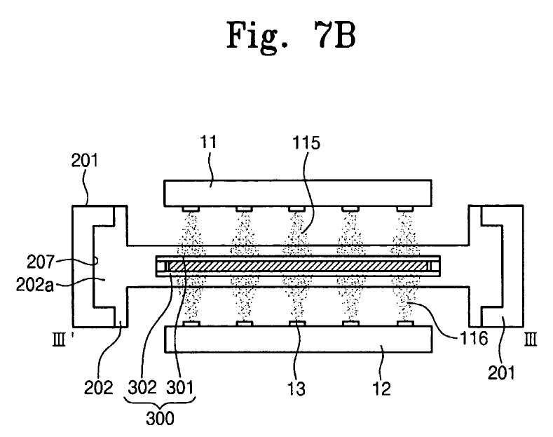

FIG. 7A is a plan view showing a substrate etching apparatus according to another exemplary embodiment of the present invention, and FIG. 7B is a cross-sectional view taken along a line III-III′ of FIG. 7A.

Referring to FIGS. 7A and 7B, the blocking shutter 201 fixes the front, rear, left, and right portions of the fixing part 202 thereto. The blocking shutter 201 is provided with an inserting groove 207 formed thereat, and the fixing part 202 is provided with a protrusion 202a formed thereon. The protrusion 202a of the fixing part 202 is inserted into the inserting groove 207, so that the blocking shutter 201 and the fixing part 202 may be firmly coupled with each other. Although not shown in FIGS. 7A and 7B, the gas layer may be additionally applied to the case that the blocking shutter 201 is mechanically coupled with the fixing part 202.

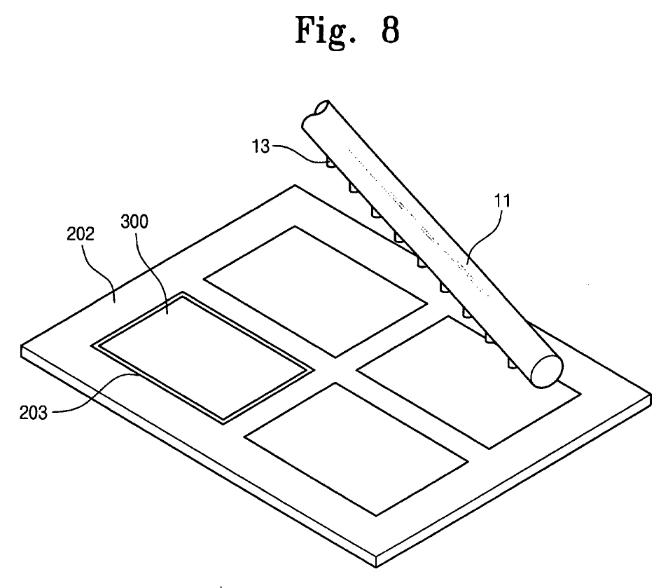

FIG. 8 is a perspective view showing a substrate etching apparatus according to another exemplary embodiment of the present invention. FIG. 8 shows a perspective view of display substrates 300 coupled with the fixing part 202.

Referring to FIG. 8, the display substrates 300 coupled with the fixing part 202 may be substantially simultaneously etched. The display substrates 300 may be coupled with the fixing part 202 by using a coupling portion 203, and several display substrates 300 may be substantially simultaneously etched, thereby improving the productivity. The coupling portion 203 may be formed together with the gas layer 206 or the protrusion 202a and the inserting groove 207 as the above-described to prevent the etchant from being moved between the first and second etching areas 4 and 5.

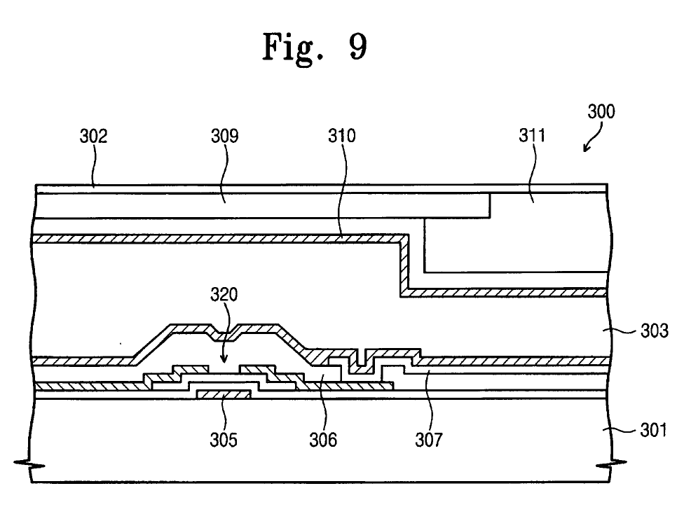

FIG. 9 is a sectional view showing a display substrate fabricated by an exemplary embodiment according to the present invention.

Referring to FIG. 9, the display substrate 300 includes the first insulating substrate 301, the second insulating substrate 302, and a light controlling layer 303. In the present exemplary embodiment, the first and second insulating substrates 301 and 302 are comprised of glass material, but the first and second insulating substrates 301 and 302 may be comprised of a plastic material depending on the selection of the etchant. The light controlling layer 303 is positioned between the first and second insulating substrates 301 and 302 and controls the light passing therethrough to display desired images.

In FIG. 9, a liquid crystal display panel has been described as including the display substrate 300. For the liquid crystal display panel, a thin film transistor 320 is formed on the first insulating substrate 301 to drive liquid crystals interposed between the first and second insulating substrates 301 and 302, and the thin film transistor 320 is covered by an insulating layer 306. A pixel electrode 307 is formed on the insulating layer 306 and electrically connected to the thin film transistor 320. The second insulating substrate 302 faces the first insulating substrate 301. A light blocking layer 309 that blocks the transmission of the light and a color filter 311 that displays predetermined colors in response to the light are formed on the second insulating substrate 302. A common electrode 310 is formed on the second insulating substrate 302 to cover the light blocking layer 309 and the color filter 311. The light controlling layer 303 is positioned between the first and second insulating substrates 301 and 302. The liquid crystal display panel employs the liquid crystals as the light controlling layer 303. The substrate etching apparatus may etch the first and second insulating substrates 301 and 302 in different thicknesses. For instance, in a driving circuit integrated type of which driving ICs are not necessary to be attached to the display substrate 300, assuming that each of the first and second insulating substrates 301 and 302 has a thickness of 0.5 mm and the first and second insulating substrates 301 and 302 are required to be etched in a thickness of 0.3 mm and 0.1 mm, respectively, the substrate etching apparatus etches the first insulating substrate 301 by a thickness of 0.2 mm while etching the second insulating substrate 302 by a thickness of 0.4 mm. As a result, the first insulating substrate 301 has the thickness of 0.3 mm, and the second insulating substrate 302 has the thickness of 0.1 mm. Thus, the display substrate 300 including the insulating substrates that are etched in different thicknesses may be readily fabricated.

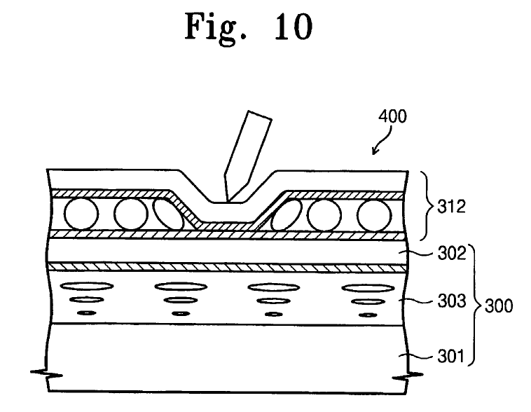

FIG. 10 is a sectional view showing a display substrate fabricated by another exemplary embodiment according to the present invention.

Referring to FIG. 10, a display substrate 400 includes the first insulating substrate 301, the second insulating substrate 302, and a touch panel substrate 312. When the touch panel substrate 312 is formed on the second insulating substrate 302, the thickness of the display substrate 400 increases due to the touch panel substrate 312. In order to prevent the increase of the thickness of the display substrate 400, the first and second insulating substrates 301 and 302 are necessary to be etched in different thicknesses. In this case, when the above-described substrate etching apparatuses are applied to etch the first and second insulating substrates 301 and 302, the first and second insulating substrates 301 and 302 may be readily etched to have the different thicknesses. Consequently, although the touch panel substrate 312 is formed on the second insulating substrate 302, the display apparatus having the thin thickness may be fabricated.

According to the above, the substrate etching apparatus may substantially simultaneously etch several substrates to have the different thicknesses without additional processes.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A substrate etching apparatus comprising:
a chamber comprising a first area and a second area adjacent to the first area, the chamber receiving a first substrate and a second substrate at a boundary between the first and second areas, the first and second substrates facing each other;
a blocking shutter positioned at the boundary between the first and second areas and surrounding end portions of the first and second substrates to isolate the first area in which the first substrate is positioned from the second area in which the second substrate is positioned;
a first spray head comprising at least one nozzle that is positioned in the first area to spray a first etchant into the first area; and
a first etchant supplier containing the first etchant and supplying the first etchant to the first spray head.

2. The substrate etching apparatus of claim 1, further comprising:
a second spray head comprising at least one nozzle that is positioned in the second area to spray a second etchant into the second area; and
a second etchant supplier containing the second etchant and supplying the second etchant to the second spray head.

3. The substrate etching apparatus of claim 2, wherein the first spray head sprays the first etchant at a spraying speed different from a spraying speed of the second etchant sprayed from the second spray head.

4. The substrate etching apparatus of claim 2, wherein the first and second etchants comprise a same composition.

5. The substrate etching apparatus of claim 4, wherein the first etchant is same as the second etchant.

6. The substrate etching apparatus of claim 2, wherein the first etchant has a composition ratio different from a composition ratio of the second etchant.

7. The substrate etching apparatus of claim 2, further comprising a third etchant supplier to supply a third etchant to the second spray head.

8. The substrate etching apparatus of claim 7, wherein the third etchant comprises a water.

9. The substrate etching apparatus of claim 2, wherein the chamber further comprises:
a first etchant withdrawal pipe connected to the first area to remove the first etchant provided to the first area; and
a second etchant withdrawal pipe connected to the second area to remove the second etchant provided to the second area.

10. The substrate etching apparatus of claim 9, wherein the first etchant withdrawal pipe is connected to the first etchant supplier, and the second etchant withdrawal pipe is connected to the second etchant supplier.

11. The substrate etching apparatus of claim 2, wherein the first and second etchants comprise fluoric acid, phosphoric acid, and nitric acid.

12. The substrate etching apparatus of claim 1, further comprising a gas layer formed between the blocking shutter and the first substrate and between the blocking shutter and the second substrate.

13. The substrate etching apparatus of claim 1, wherein the blocking shutter further comprises a protrusion which extends from a surface of the blocking shutter in a direction substantially perpendicular to edges of the first and second substrates to prevent the first and second etchants from being moved to the second and first areas, respectively.

14. The substrate etching apparatus of claim 1, further comprising a fixing part receiving end portions of the first and second substrates therein and fixing the first and second substrates thereto, the fixing part being positioned between the first substrate and the blocking shutter and between the second substrate and the blocking shutter.

15. The substrate etching apparatus of claim 13, further comprising a gas layer formed between the blocking shutter and the fixing part.

16. The substrate etching apparatus of claim 14, wherein the fixing part further comprises a protrusion extending from a surface of the blocking shutter in a direction substantially perpendicular to the first and second substrates.

17. The substrate etching apparatus of claim 14, wherein the blocking shutter comprises a first coupling portion formed at a surface facing the fixing part thereof, the fixing part comprises a second coupling portion coupled with the first coupling portion, and one coupling portion of the first and second coupling portions is a protrusion and a remaining portion of the first and second coupling portions is an inserting groove.

18. A method of etching a substrate, comprising:
loading a first substrate and a second substrate facing the first substrate into a chamber;
coupling a blocking shutter positioned inside the chamber with end portions of the first and second substrates to isolate a space inside the chamber into a first area in which the first substrate is positioned and a second area in which the second substrate is positioned; and
spraying a first etchant to the first substrate to be differently etched from the second substrate.

19. The method of claim 18, further comprising spraying a second etchant to the second substrate to be etched after isolating the first and second areas with each other.

20. The method of claim 19, wherein the first etchant is sprayed at a spraying speed different from a spraying speed of the second etchant.

21. The method of claim 19, wherein the second etchant comprises a water.

22. The method of claim 19, wherein the first and second etchants comprise fluoric acid, phosphoric acid, and nitric acid.

23. The method of claim 22, wherein the first etchant has a composition ratio different from a composition ratio of the second etchant.

24. The method of claim 22, wherein each of the first and second etchants comprises at least one of a glycol-containing medium and a glycerol-containing medium.

25. The method of claim 18, further comprising forming a gas layer between the blocking shutter and the first substrate and between the blocking shutter and the second substrate after isolating the first and second areas with each other.

26. The method of claim 18, further comprising:
coupling the end portions of the first and second substrates with a fixing part before loading the first and second substrates into the chamber; and
coupling the fixing part with the blocking shutter to fix the first and second substrates after loading the first and second substrates into the chamber.

27. The method of claim 26, further comprising forming a gas layer between the blocking shutter and the fixing part.
